(19) United States
(12) Patent Application Publication
(10) Pub. No.: US 2026/0030277 A1
(43) Pub. Date: Jan. 29, 2026

(54) METHOD AND SYSTEM FOR EXTRACTING DATA FROM A DATABASE AND GENERATING A RESPONSE TO A NATURAL LANGUAGE QUERY

(71) Applicant: JPMorgan Chase Bank, N.A., New York, NY (US)

(72) Inventors: Deepshikha AGARWAL, Mumbai (IN); Mark A COYLE, Essex (GB); Krishna SESHADRI, Jersey City, NJ (US); Anshul BHATNAGAR, Thane (IN)

(73) Assignee: JPMorgan Chase Bank, N.A., New York, NY (US)

(21) Appl. No.: 19/272,663

(22) Filed: Jul. 17, 2025

(30) Foreign Application Priority Data
Jul. 27, 2024 (IN) 202411057142

(51) Int. Cl. G06F 16/334; G06F 9/451; G06F 16/338

(52) U.S. Cl. CPC G06F 16/3344; G06F 9/451; G06F 16/338

(57) ABSTRACT

A method and a system for querying database data using natural language are provided. The method includes: receiving, via a user interface, a natural language query to extract domain data from a database; analyzing, using a public cloud platform, the natural language query to determine a first database associated with the natural language query; generating, using the public cloud platform and based on a result of the analysis, a prompt for understanding the first database; transmitting the natural language query and the prompt to a second model that is a large language model (LLM); generating, using the second model and based on the transmitted natural language query and the prompt, a database-specific query; transmitting the database-specific query to the first database; generating, using the first database, a response to the natural language query; and transmitting the response to the user interface.

### CROSS-REFERENCE TO RELATED APPLICATIONS

This application claims priority benefit from Indian Application No. 202411057142, filed on Jul. 27, 2024, in the India Patent Office, which is hereby incorporated by reference in its entirety.

### BACKGROUND

### 1. Field of the Disclosure

This technology generally relates to methods and systems for querying database data using natural language, and more particularly to methods and systems for automatically converting a natural language query into structured language to extract a response from a domain specific database.

### 2. Background Information

Conventional tools require extensive training and use of third-party systems in order for businesses to get information about domain data. Moreover, the use of these conventional tools is often very tedious and time-consuming. Also, these conventional tools relay on user interfaces (UIs) that are limited to pre-defined requirements such that out-of-box requirements cannot be handled by the tool. Moreover, because of their complexity, these conventional tools often have to be operated by specialized technology focused teams in order to process the data retrieval requests. These teams may receive a high volume of ad hoc requests for this data, which may impose large time constraints and limit available resources.

Accordingly, there is a need for systems and methods that are designed to automatically convert natural language queries into structured language to extract a response from a domain specific database.

### SUMMARY

The present disclosure, through one or more of its various aspects, embodiments, and/or specific features or sub-components, provides, inter alia, various systems, servers, devices, methods, media, programs, and platforms for automatically converting a natural language query into structured language to extract a response from a domain specific database. According to an aspect of the present disclosure, a method for querying database data using natural language is provided. The method may be implemented by at least one processor. The method may include: receiving, by the at least one processor via a user interface, a natural language query to extract domain data from a database; analyzing, by the at least one processor via a public cloud platform, the natural language query to determine a first database associated with the natural language query; generating, by the at least one processor via the public cloud platform and based on a result of the analyzing, a prompt for understanding the first database; transmitting, by the at least one processor, the natural language query and the prompt to a second model that is a large language model (LLM); generating, by the at least one processor via the second model and based on the transmitted natural language query and the prompt, a database-specific query; transmitting, by the at least one processor, the database-specific query to the first database; generating, by the at least one processor via the first database, a response to the natural language query; and transmitting, by the at least one processor, the response to the user interface.

The method may further include receiving context information from the first database and using the received context information and the result of the analyzing for the generating of the prompt.

The prompt may include a series of rules and instructions specific to the first database that relate to a language structure required for the generating of the database-specific query.

The public cloud platform may have a language model integration framework.

The answer may be displayed on the user interface in a natural language format.

The method may further include receiving, by the at least one processor, a request to extract data from a document; analyzing, by the at least one processor via the public cloud platform, the request to determine a first document associated with the request; generating, by the at least one processor via the public cloud platform and based on the analyzing of the request, a first instruction for understanding the first document; transmitting, by the at least one processor, the request and the first instruction to the second model; extracting, by the at least one processor via the second model and based on the transmitted request and the first instruction, request-specific data from the document; and transmitting, by the at least one processor, the request-specific data to the user interface.

The user interface may comprise a chatbot interface.

The public cloud platform may be trained using historical natural language query results.

According to another aspect of the present disclosure, a computing apparatus for querying database data using natural language is provided. The computing apparatus may include a processor; a memory; and a communication interface coupled to each of the processor and the memory. The processor may be configured to: receive, via a user interface, a natural language query to extract domain data from a database; analyze, via a public cloud platform, the natural language query to determine a first database associated with the natural language query; generate, via the public cloud platform and based on a result of the analysis, a prompt for understanding the first database; transmit the natural language query and the prompt to a second model that is a large language model (LLM); generate, via the second model and based on the transmitted natural language query and the prompt, a database-specific query; transmit the database-specific query to the first database; generate, via the first database, a response to the natural language query; and transmit the response to the user interface.

The processor may be further configured to receive context information from the first database and use the received context information and the result of the analysis for the generating of the prompt.

The prompt may include a series of rules and instructions specific to the first database that relate to a language structure required for the generating of the database-specific query.

The public cloud platform may have a language model integration framework.

The answer may be displayed on the user interface in a natural language format.

The processor may be further configured to: receive a request to extract data from a document; analyze, via the public cloud platform, the request to determine a first document associated with the request; generate, via the public cloud platform and based on the analysis of the request, a first instruction for understanding the first document; transmit the request and the first instruction to the second model; extract, via the second model and based on the transmitted request and the first instruction, request-specific data from the document; and transmit the request-specific data to the user interface.

The user interface may be a chatbot interface.

The public cloud platform may be trained using historical natural language query results.

According to yet another aspect of the present disclosure, a non-transitory computer readable storage medium storing instructions for querying database data using natural language is provided. The storage medium includes executable code which, when executed by a processor, may cause the processor to: receive, via a user interface, a natural language query to extract domain data from a database; analyze, via a public cloud platform, the natural language query to determine a first database associated with the natural language query; generate, via the public cloud platform and based on a result of the analysis, a prompt for understanding the first database; transmit the natural language query and the prompt to a second model that is a large language model (LLM); generate, via the second model and based on the transmitted natural language query and the prompt, a database-specific query; transmit the database-specific query to the first database; generate, via the first database, a response to the natural language query; and transmit the response to the user interface.

The executable code may further cause the processor to receive context information from the first database and use the received context information and the result of the analysis for the generating of the prompt.

The prompt may include a series of rules and instructions specific to the first database that relate to a language structure required for the generating of the database-specific query.

The public cloud platform may have a language model integration framework.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for automatically converting a natural language query into structured language to extract a response from a domain specific database in accordance with an embodiment.

FIG. 2 illustrates a diagram of a network environment for automatically converting a natural language query into structured language to extract a response from a domain specific database in accordance with an embodiment.

FIG. 3 illustrates a system diagram of a system for automatically converting a natural language query into structured language to extract a response from a domain specific database in accordance with an embodiment.

FIG. 4 illustrates a process diagram of a process for automatically converting a natural language query into structured language to extract a response from a domain specific database.

FIG. 5 illustrates a flow diagram of a process for automatically converting a natural language query into structured language to extract a response from a domain specific database.

FIG. 6 illustrates a flow diagram of a process for automatically converting a natural language query into structured language to extract a response from a domain specific database.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

A system or method disclosed herein receives a query written in natural language that requests the extraction of specific data from a database. The system analyzes the query to determine which database the requested data is associated with. Next, the system generates a prompt for structuring the natural language queries to a format that is capable of extracting data from the identified database. The system then sends both the prompt and the natural language query to an LLM. The system then uses the LLM to generate a database-specific query that is based on the natural language query and the generated prompt. The database-specific query is then transmitted to the database to retrieve a response to the request from the natural language query. Then, the retrieved response is transmitted to a user interface for display.

This system and method provide multiple advantages over existing technology. For example, the system enhances user experience by internally structuring database-specific queries without additional prompts or inputs and without the dependency on third-party applications/systems or technology support. In conventional systems, users need to access multiple applications and/or data sources to obtain specific database related data. However, this system creates a one stop shop for data that enables users to use a single user interface for all data related queries to ensure availability and quality. Moreover, conventional systems and technology require training and a learning period in order to adequately structure request so as to retrieve the appropriate data, whereas this system enables the use of natural language without any training or learning period. Additionally, the system enhances efficiency by reducing lead time for data analysis. Particularly, this LLM based solution can adapt to human queries seamlessly, reducing the lead time from a few days to a few minutes.

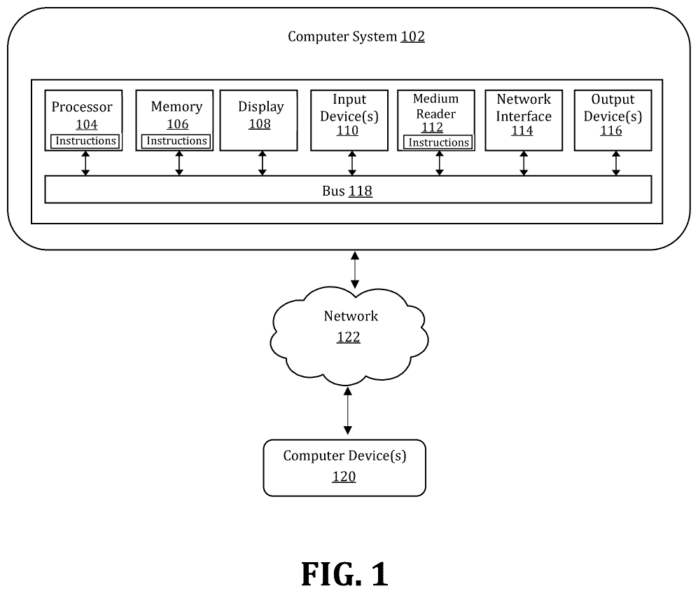

FIG. 1 is a system 100 for automatically converting a natural language query into structured language to extract a response from a domain specific database in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional or alternative input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the query analyzing module implemented by the system 100 may allow for automatically converting a natural language query into structured language to extract a response from a domain specific database. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

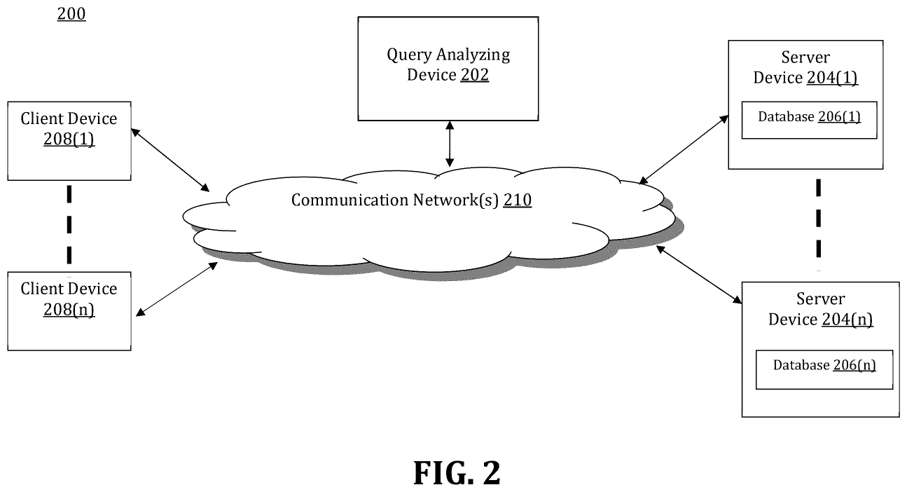

Referring to FIG. 2, a schematic of a network environment 200 for automatically converting a natural language query into structured language to extract a response from a domain specific database of the instant disclosure is illustrated.

In some embodiments, the above-described problems associated with conventional tools may be overcome by implementing a query analyzing device 202 as illustrated in FIG. 2 that may be configured for automatically converting a natural language query into structured language to extract a response from a domain specific database, but the disclosure is not limited thereto.

The query analyzing device 202 may include one or more computer systems 102, as described with respect to FIG. 1, which in aggregate provide the necessary functions.

The query analyzing device 202 may store one or more applications that can include executable instructions that, when executed by the query analyzing device 202, cause the query analyzing device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the query analyzing device 202 itself, may be located in virtual server(s) running in a cloud-based computing environment rather than being tied to one or more specific physical network computing devices. Also, the application(s) may be running in one or more virtual machines (VMs) executing on the query analyzing device 202. Additionally, in one or more embodiments of this technology, virtual machine(s) running on the query analyzing device 202 may be managed or supervised by a hypervisor.

In the network environment 200 of FIG. 2, the query analyzing device 202 may be coupled to a plurality of server devices 204(1)-204(n) that hosts a plurality of databases 206(1)-206(n), and also to a plurality of client devices 208(1)-208(n) via communication network(s) 210. A communication interface of the query analyzing device 202, such as the network interface 114 of the computer system 102 of FIG. 1, operatively couples and communicates between the query analyzing device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the query analyzing device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The query analyzing device 202 may be a standalone device or integrated with one or more other devices or apparatuses, such as one or more of the server devices 204(1)-204(n), for example. In one particular example, the query analyzing device 202 may be hosted by one of the server devices 204(1)-204(n), and other arrangements are also possible. Moreover, one or more of the devices of the query analyzing device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the query analyzing device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) host the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the query analyzing device 202 that may efficiently provide a platform for automatically converting a natural language query into structured language to extract a response from a domain specific database, but the disclosure is not limited thereto.

The client devices 208(1)-208(n) may run interface applications, such as standard web browsers or standalone client applications, which may provide an interface to communicate with the query analyzing device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the query analyzing device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the query analyzing device 202, the server devices 204(1)-204(n), or the client devices 208(1)-208(n), for example, may be configured to operate as virtual instances on the same physical machine. For example, one or more of the query analyzing device 202, the server devices 204(1)-204(n), or the client devices 208(1)-208(n) may operate on the same physical device rather than as separate devices communicating through communication network(s) 210. Additionally, there may be more or fewer query analyzing devices 202, server devices 204(1)-204(n), or client devices 208(1)-208(n) than illustrated in FIG. 2. In some embodiments, the query analyzing device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

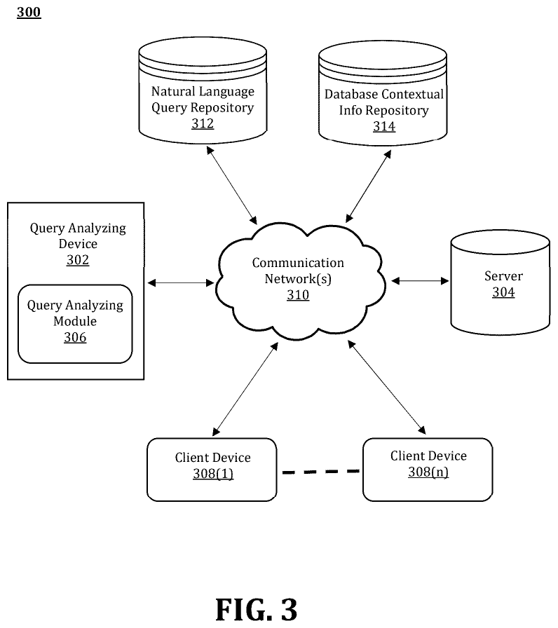

FIG. 3 illustrates a system diagram for automatically converting a natural language query into structured language to extract a response from a domain specific database in accordance with an embodiment.

As illustrated in FIG. 3, the system 300 may include an query analyzing device 302 within which an query analyzing module 306 is embedded, a server 304, a natural language query repository 312, a database contextual info repository 314, a plurality of client devices 308(1) . . . 308(n), and a communication network 310.

In some embodiments, the query analyzing device 302 including the query analyzing module 306 may be connected to the server 304, and the database(s) 312 via the communication network 310. The query analyzing device 302 may also be connected to the plurality of client devices 308(1) . . . 308(n) via the communication network 310, but the disclosure is not limited thereto. The natural language query repository 312 and the database contextual info repository 314 may include one or more repositories or rule databases.

In an embodiment, the query analyzing device 302 is described and shown in FIG. 3 as including the query analyzing module 306, although it may include other rules, policies, modules, databases, or applications, for example. In some embodiments, the natural language query repository 312 and the database contextual info repository 314 may be configured to store ready-to-use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the natural language query repository 312 and the database contextual info repository 314 may store the large code-based models as directed graphs and graph metrics and graph centrality measures.

In some embodiments, the query analyzing module 306 may be configured to receive a real-time feed of data from the plurality of client devices 308(1) . . . 308(n) and secondary sources via the communication network 310.

The query analyzing module 306 may be configured to: receive, via a user interface, a natural language query to extract domain data from a database; analyze, using a public cloud platform, the natural language query to determine a first database associated with the natural language query; generate, using the public cloud platform and based on a result of the analyzing, a prompt for understanding the first database; transmit the natural language query and the prompt to a second model that is an LLM; generate, using the second model and based on the transmitted natural language query and the prompt, a database-specific query; transmit the database-specific query to the first database; generate, using the first database, a response to the natural language query; transmit the response to the user interface, but the disclosure is not limited thereto.

The plurality of client devices 308(1) . . . 308(n) are illustrated as being in communication with the query analyzing device 302. In this regard, the plurality of client devices 308(1) . . . 308(n) may be “clients” (e.g., customers) of the query analyzing device 302 and are described herein as such. Nevertheless, it is to be known and understood that the plurality of client devices 308(1) . . . 308(n) need not necessarily be “clients” of the query analyzing device 302, or any entity described in association therewith herein. Any additional or alternative relationship may exist between either or both of the plurality of client devices 308(1) . . . 308(n) and the query analyzing device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the query analyzing device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The query analyzing device 302 may be the same or similar to the query analyzing device 202 as described with respect to FIG. 2, including any features or combination of features described with respect thereto.

Upon being started, the query analyzing device 302 executes a process for automatically converting a natural language query into structured language to extract a response from a domain specific database.

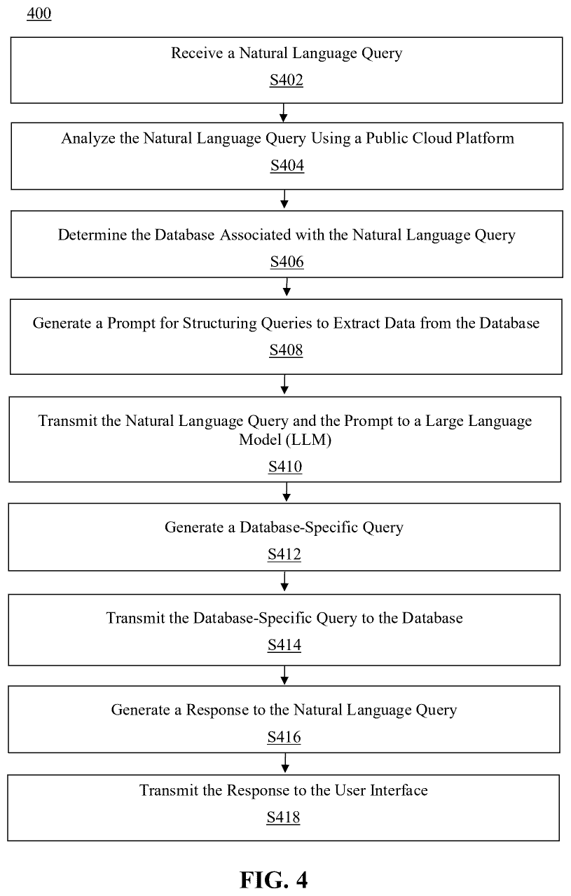

Referring to FIG. 4, a process 400 for automatically converting a natural language query into structured language to extract a response from a domain specific database is illustrated, according to an embodiment.

In process 400 of FIG. 4, at step S402, the query analyzing device 302 may receive a natural language query. In an embodiment, the natural language query may require information from a domain specific database. In some embodiments, the natural language query may be received from a user interface. In an embodiment, the user interface may be a chatbot based user interface. In some embodiments, the at least one natural language query may be received from at least one of a user, a query raising system, and a third-party platform. In a non-limiting example, the user may be a member of a business team who wants to raise the query in natural language. In an embodiment, the at least one natural language query may be received either in a speech format or in a text format. Further, the at least one natural language query may include at least one query received in a natural language format.

At step S404, the query analyzing device 302 may analyze the natural language query using a public cloud platform. In some embodiments, the public cloud platform may have a language model integration framework. In an embodiment, the public cloud platform may have a LangChain framework. In some embodiments, the public cloud platform may be trained using historical natural language query results. The historical natural language query results may relate to previously received or generated natural language queries and the resulting structured queries. Then, at step S406, the query analyzing device 302 may use the public cloud platform to determine which database is associated with the natural language query. In an embodiment, the public cloud platform may receive context information from the database.

At step S408, the query analyzing device 302 may generate a prompt that includes details for structuring queries to extract data from the database. In some embodiments, the prompt may include a series of rules and instructions specific to the first database that relate to a language structure required for the generating of the database-specific query. In an embodiment, the prompt may be specific to the criteria of the database for which the data is being retrieved.

At step S410, the query analyzing device 302 may transmit the natural language query and the prompt to an LLM. Then, at step S412 the LLM may generate a database-specific query for extracting the requested data from the database. In some embodiments, the database-specific query may be formatted in a structured query language. In an embodiment, the prompt may be used in conjunction with the natural language query to generate the database-specific query in structured query language based on the context information used by the public cloud platform for generating the prompt.

At step S414, the query analyzing device 302 may transmit the database-specific query to the database. Then, at step S416, the database may generate a response to the natural language query.

Then, at step S418, the response to the natural language query generated by the database may be transmitted to the user interface. In an embodiment, the response may be first transmitted to the public cloud platform so that the public cloud platform may format the response in a natural language format. The public cloud platform may then transmit the natural language response to the user interface.

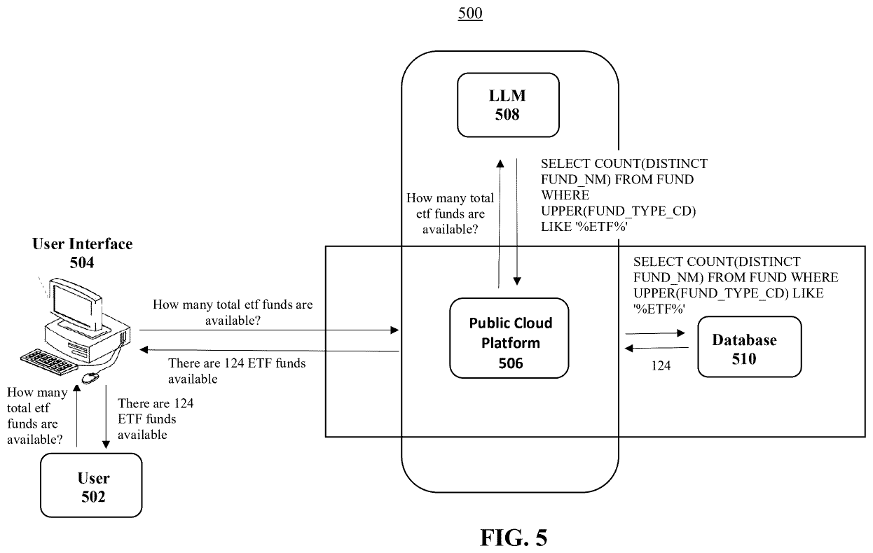

FIG. 5 illustrates a flow diagram 500 of a process for automatically converting a natural language query into structured language to extract a response from a domain specific database, according to an embodiment. As illustrated in FIG. 5, at least one user 502 may input a natural language query into a user interface 504 to obtain data from a domain specific database. For example, as illustrated in the FIG. 5, the query may include “How many total etf funds are available?” The user interface 504 may then transmit the natural language query to the public cloud platform 506.

The public cloud platform 506 may then analyze the natural language query and generate a prompt that includes specific instructions for formatting queries to extract data from a database 510. The public cloud platform 506 may then transmit the natural language query and the prompt to an LLM 508.

The LLM 508 may then use the natural language query and the prompt to generate a database-specific query that may be in a structured query language. For example, as illustrated in the FIG. 5, the query “How many total etf funds are available” may be translated into “SELECT COUNT(DISTINCT FUND NM) FROM FUND WHERE UPPER(FUND_TYPE_CD) LIKE ‘% ETF %’.” The database-specific query may then be transmitted back to the public cloud platform 506 which then transmits the database-specific query to the appropriate database 510.

Once the database 510 receives the database-specific query it may generate a response to the query. For example, as illustrated in the FIG. 5, in response to the database-specific query “SELECT COUNT(DISTINCT FUND NM) FROM FUND WHERE UPPER(FUND_TYPE_CD) LIKE ‘% ETF %’” the database 510 may generate the response “124.” The response generated by the database 510 may then be transmitted to the public cloud platform 506. The public cloud platform may then translate the response to natural language based on the natural language query. For example, as illustrated in the FIG. 5, based on the query “How many total etf funds are available,” the response “124” may be translated into “There are 124 ETF funds available.” The natural language response is then transmitted from the public cloud platform 506 to the user interface 504 so that it can be read by the at least one user 502.

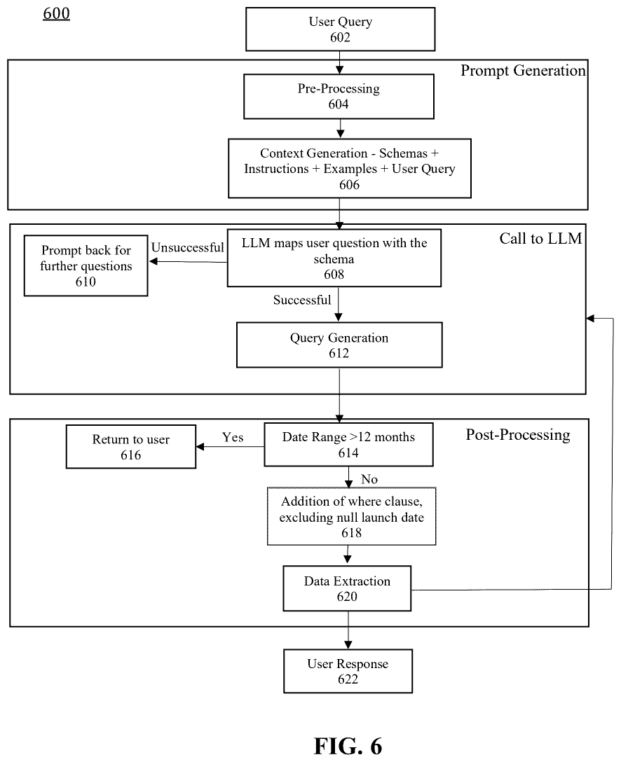

FIG. 6 illustrates a flow diagram 600 for automatically converting a natural language query into structured language to extract a response from a domain specific database, according to an embodiment.

In the flow diagram 600 of FIG. 6, at step 602 a user query is received and is transmitted to a prompt generation component for pre-processing at step 604. Based on the pre-processing, the system at step 606 is able to generate contextual identifiers for the user query. The contextual identifiers may include schemas, instructions, examples, and the user query itself. The generated contextual information is then transmitted to another component responsible for making calls to an LLM. In an embodiment, the generation of the contextual identifiers may be based on previous queries or conversations with the user. This may enable the system to understand the query/conversation better and give more helpful answers or context driven responses.

At step 608, the system uses an LLM to map the user query with an appropriate generated schema, based on the generated contextual identifiers from step 606. If the mapping is unsuccessful, the system proceeds to step 610, and a prompt is generated back to user with further questions for revising the query. In some embodiments, the prompt and/or output by the system may be a natural language explanation. If the mapping is successful, the system proceeds to step 612 and generates a structured query. The structured query is then transmitted to a post-processing component.

Then, at step 614, the system determines if the requested date range within the query is within a predetermined range (e.g., 12 months). If the date range is greater than the predetermined range (e.g., greater than 12 months before the current date), the system proceeds to step 616 and a prompt is returned to the user with the information that the system cannot be used to extract data older than a predetermined time frame (e.g., a year). If the date range falls within the predetermined range, the system proceeds to step 618, and a where clause is added to the structured query. At step 620, data is extracted from database using the structured query. Additionally, the structured query and extracted data is transmitted back to the call to LLM component in order to further train this component and improve the speed and accuracy of future query processing. Then, at step 622, the extracted data is transmitted to the user in the form of a response to the user's initial query.

In an embodiment, the query analyzing device 302 may be a robust artificial intelligence (AI) powered system that facilitates businesses in daily routine tasks by allowing users to ask questions to relational databases via natural language. The query analyzing device 302 may enhance user experience and avoid dependency on specialized teams.

In an embodiment, the query analyzing device 302 may be an LLM empowered solution that can help provide a single interface to answer all domain database specific questions. In an embodiment, the query analyzing device 302 may also include visualization/prediction features. The query analyzing device 302 may be implemented to a plurality of businesses, for example instruments/account management and client management, and may also be deployed across a multitude of business functions, for example financial operation, risk management, and finance. Moreover, the query analyzing module 302 may be integrated with and/or compliment other data/documents such as legal documents and/or fact sheets.

In an embodiment, the query analyzing device 302 may be backed up by LLMs and LangChain Framework. LangChain Framework is an open-source framework for developing applications which can process natural language using LLMs. LLMs lack domain knowledge, but this gap may be filled in by prompts and LangChain structured query language (SQL) that retrieve context information from the database and transmit it along with the user input to the LLM and generate an enriched and relevant response.

The query analyzing device 302 may include a feedback mechanism, in which once a user gets a response they can provide feedback. The feedback may get recorded and used to help analyze and improve solutions in a recursive process.

The query analyzing device 302 may enhance efficiency by reducing lead time for data analysis. This query analyzing device 302 may seamlessly adapt to human queries, reducing the lead time from a few days to a few minutes. Additionally, the query analyzing device 302 may provide a one stop shop for data. Conventional systems require access to multiple applications/data sources to obtain domain-specific data. The query analyzing device 302 may enable use of a single user interface for all data related queries. Conventional systems require extensive training to effectively use the third-party software. This tool enables access to information using human language without requiring training or extensive learning periods.

Accordingly, with this technology, an optimized process for automatically converting a natural language query into structured language to extract a response from a domain specific database is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for querying database data using natural language, the method being implemented by at least one processor, the method comprising:
receiving, by the at least one processor via a user interface, a natural language query to extract domain data from a database;
analyzing, by the at least one processor via a public cloud platform, the natural language query to determine a first database associated with the natural language query;
generating, by the at least one processor via the public cloud platform and based on a result of the analyzing, a prompt for understanding the first database;
transmitting, by the at least one processor, the natural language query and the prompt to a second model that is a large language model (LLM);
generating, by the at least one processor via the second model and based on the transmitted natural language query and the prompt, a database-specific query;
transmitting, by the at least one processor, the database-specific query to the first database;
generating, by the at least one processor via the first database, a response to the natural language query; and
transmitting, by the at least one processor, the response to the user interface.

2. The method of claim 1, further comprising:
receiving context information from the first database and using the received context information and the result of the analyzing for the generating of the prompt.

3. The method of claim 1, wherein the prompt includes a series of rules and instructions specific to the first database that relate to a language structure required for the generating of the database-specific query.

4. The method of claim 1, wherein the public cloud platform has a language model integration framework.

5. The method of claim 1, wherein the answer is displayed on the user interface in a natural language format.

6. The method of claim 1, further comprising:
receiving, by the at least one processor, a request to extract data from a document;
analyzing, by the at least one processor via the public cloud platform, the request to determine a first document associated with the request;
generating, by the at least one processor via the public cloud platform and based on the analyzing of the request, a first instruction for understanding the first document;
transmitting, by the at least one processor, the request and the first instruction to the second model;
extracting, by the at least one processor via the second model and based on the transmitted request and the first instruction, request-specific data from the document; and
transmitting, by the at least one processor, the request-specific data to the user interface.

7. The method of claim 1, wherein the user interface comprises a chatbot interface.

8. The method of claim 1, wherein the public cloud platform is trained using historical natural language query results.

9. A computing device configured for querying database data using natural language, the computing device comprising:
a processor;
a memory; and
a communication interface coupled to each of the processor and the memory, wherein the processor is configured to:
receive, via a user interface, a natural language query to extract domain data from a database;
analyze, via a public cloud platform, the natural language query to determine a first database associated with the natural language query;
generate, via the public cloud platform and based on a result of the analysis, a prompt for understanding the first database;
transmit the natural language query and the prompt to a second model that is a large language model (LLM);
generate, via the second model and based on the transmitted natural language query and the prompt, a database-specific query;
transmit the database-specific query to the first database;
generate, via the first database, a response to the natural language query; and
transmit the response to the user interface.

10. The computing apparatus of claim 9, wherein the processor is further configured to:
receive context information from the first database and use the received context information and the result of the analysis for the generating of the prompt.

11. The computing apparatus of claim 9, wherein the prompt includes a series of rules and instructions specific to the first database that relate to a language structure required for the generating of the database-specific query.

12. The computing apparatus of claim 9, wherein the public cloud platform has a language model integration framework.

13. The computing apparatus of claim 9, wherein the answer is displayed on the user interface in a natural language format.

14. The computing apparatus of claim 9, wherein the processor is further configured to:
receive a request to extract data from a document;
analyze, via the public cloud platform, the request to determine a first document associated with the request;
generate, via the public cloud platform and based on the analysis of the request, a first instruction for understanding the first document;
transmit the request and the first instruction to the second model;
extract, via the second model and based on the transmitted request and the first instruction, request-specific data from the document; and
transmit the request-specific data to the user interface.

15. The computing apparatus of claim 9, wherein the user interface comprises a chatbot interface.

16. The computing apparatus of claim 9, wherein the public cloud platform is trained using historical natural language query results.

17. A non-transitory computer readable storage medium storing instructions for querying database data using natural language, the storage medium comprising executable code which, when executed by a processor, causes the processor to:
receive, via a user interface, a natural language query to extract domain data from a database;
analyze, via a public cloud platform, the natural language query to determine a first database associated with the natural language query;
generate, via the public cloud platform and based on a result of the analysis, a prompt for understanding the first database;
transmit the natural language query and the prompt to a second model that is a large language model (LLM);
generate, via the second model and based on the transmitted natural language query and the prompt, a database-specific query;
transmit the database-specific query to the first database;
generate, via the first database, a response to the natural language query; and
transmit the response to the user interface.

18. The storage medium of claim 17, wherein, when executed by the processor, the executable code further causes the processor to:
receive context information from the first database and use the received context information and the result of the analysis for the generating of the prompt.

19. The storage medium of claim 17, wherein the prompt includes a series of rules and instructions specific to the first database that relate to a language structure required for the generating of the database-specific query.

20. The storage medium of claim 17, wherein the public cloud platform has a language model integration framework.
